(19) United States
(12) Patent Application Publication
(10) Pub. No.: US 2006/0282314 A1
(43) Pub. Date: Dec. 14, 2006

(54) Universal advertisement services architecture

(75) Inventors: M.S. Kiumarse Zamanian, Hillsborough, CA (US); Hongche Liu, Fremont, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/150,556

(22) Filed: Jun. 10, 2005

(51) Int. Cl. G06Q 30/00

(52) U.S. Cl. 705/14

(57) ABSTRACT

A universal advertisement services system provides a common framework for managing web-based advertisement campaigns associated with various kinds of advertisement formats and advertisement pricing mechanisms. A unified set of interfaces is provided for advertisement configuration, fetching, arbitration and optimization, and advertisement campaign validation, exposing services to external parties as well as internal users. The universal advertisement services system enables delivery of an optimal available guaranteed or performance-based advertisement for a specified position in a web page and based on given business rules and metrics.

### FIELD OF THE INVENTION

The present invention relates generally to providing advertisements over a network, and more particularly, but not exclusively, to providing services for selecting and distributing different advertisements for inclusion in a page.

### BACKGROUND OF THE INVENTION

Online advertising is often a principal source of revenue for enterprises engaged in electronic commerce. A number of different types of page-based online advertisements are in use, along with various associated distribution requirements, advertising metrics, and pricing mechanisms. The Hypertext Markup Language (HTML) and Hypertext Transfer Protocol (HTTP) processes enable a page to be configured to contain a position for inclusion of an advertisement that can be selected dynamically each time the page is requested for display in a browser.

One type of online advertisement for products and/or services is a banner advertisement, which typically features an image (animated or static), and/or text displayed at a predetermined position in a page. The banner advertisement usually takes the form of a horizontal rectangle at the top of the page, but it can also be arranged in a variety of other shapes at any other location on the page. If a user clicks on the banner advertisement's location, image, and/or text, the user is taken to a new page that may provide detailed information regarding the products and/or services associated with the banner advertisement.

Another exemplary type of online advertisement is the sponsored listing advertisement. Sponsored listing advertisements can be represented by text and/or images that are displayed in a listing based on a user's search criteria or user browsing data. For example, if a user enters a search query in a web-based search engine, a set of hyperlinked text listings may be displayed in a position in the returned page along with the search query results. Sponsored listing advertisements are often provided according to a bidding model in which advertisers bid on keywords and the higher bids win placement in a listing, and pricing is often calculated on a “pay for clicks” and/or frequency basis.

Advertisement serving technology currently suffers from a proliferation of diverse interfaces, tools, and frameworks for choosing, distributing, and displaying advertisements in pages. For example, a web portal service may have to interact with several internal content managers and external partners that use different and incompatible tools for providing advertisements of particular types. As a consequence, advertisements are often manually reconfigured for use with different serving systems. Such conditions have impeded the deployment, testing, maintenance, and extension of systems that provide advertisements for display in a page.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 is a diagram illustrating one embodiment of an environment for practicing the invention;

FIG. 2 illustrates elements of a multiple-tiered framework that may form the basis of a system implementing the invention;

FIG. 3 is a block diagram illustrating in further detail a set of interfaces for universal advertisement services;

FIG. 4 is a block diagram illustrating in further detail components for arbitration and optimization services;

FIG. 5 illustrates a logical flow diagram generally showing one embodiment of a process for enabling the display of a page with an advertisement at a predetermined location;

FIG. 6 illustrates a logical flow diagram generally showing one embodiment of a process for selecting an advertisement for display at a location in a page;

FIG. 7 illustrates a logical flow diagram generally showing one embodiment of a process for initiating arbitration of an advertisement request;

FIG. 8 illustrates a logical flow diagram generally showing one embodiment of a process for providing an arbitrated advertisement; and

FIG. 9 illustrates a logical flow diagram generally showing one embodiment of a process for selection of an optimal advertisement, in accordance with the invention.

### DETAILED DESCRIPTION OF THE INVENTION

The present invention will now be described more fully hereinafter with reference to the accompanying drawings, which form a part hereof, and which show, by way of illustration, specific exemplary embodiments by which the invention may be practiced. The invention may, however, be embodied in many different forms and should not be regarded as limited to the embodiments set forth herein. Rather, these embodiments are provided so that this disclosure will be thorough and complete and will convey fully the scope of the invention to those skilled in the art. The following detailed description is, therefore, not to be taken in a limiting sense.

The invention is directed towards an advertisement services architecture that provides a common framework for universally managing network-based advertisement campaigns associated with various types of advertisement formats and advertisement cost mechanisms. A unified group of interfaces is provided for advertisement configuration, fetching, arbitration and optimization, advertisement campaign validation, and exposing services to external parties as well as to internal users. The invention can be employed with different types of advertisements including banner advertisements, sponsored listing advertisements, and the like. Additionally, an audio clip or sound can be associated with the different kinds of advertisements, which can be played when a page is displayed or if a pointing device is proximate to the advertisement's location in the page.

One aspect of the invention can employ business rules and metrics to optimize the delivery of a guaranteed number of impressions of an advertisement or a performance-based display of advertisements for a specified location in a page. Other aspects of the invention can provide for obtaining a configuration for a page location for displaying an advertisement; determining at least one advertisement that meets the configuration requirements, e.g., size and type; and determining an advertisement for display based on one or more optimization rules.

One type of advertisement enables an advertiser to specifically identify the number of guaranteed impressions to be delivered to a specific audience over a given period of time, where an “impression” is a single advertisement displayed to one user. Other types of advertisements enable an advertiser to specify a budget for displaying the advertisements over a period of time to a user(s), maximum amount to pay for each impression, and the like, based on a particular action or “performance” such as a keyword provided by a user in a search request.

For different types of advertisements, the dynamic selection of a particular advertisement for display in a page may be based on a wide range of considerations, including user browsing and interaction history, user registration information, page subject matter, search terms, distribution methods, and the like. Banner advertisements are often provided on a guaranteed number of impressions basis or they may be performance-based. Similarly, sponsored link advertisements are generally provided on a performance basis, but they can also be provided on a guaranteed number of impressions basis.

Illustrative Operating Environment

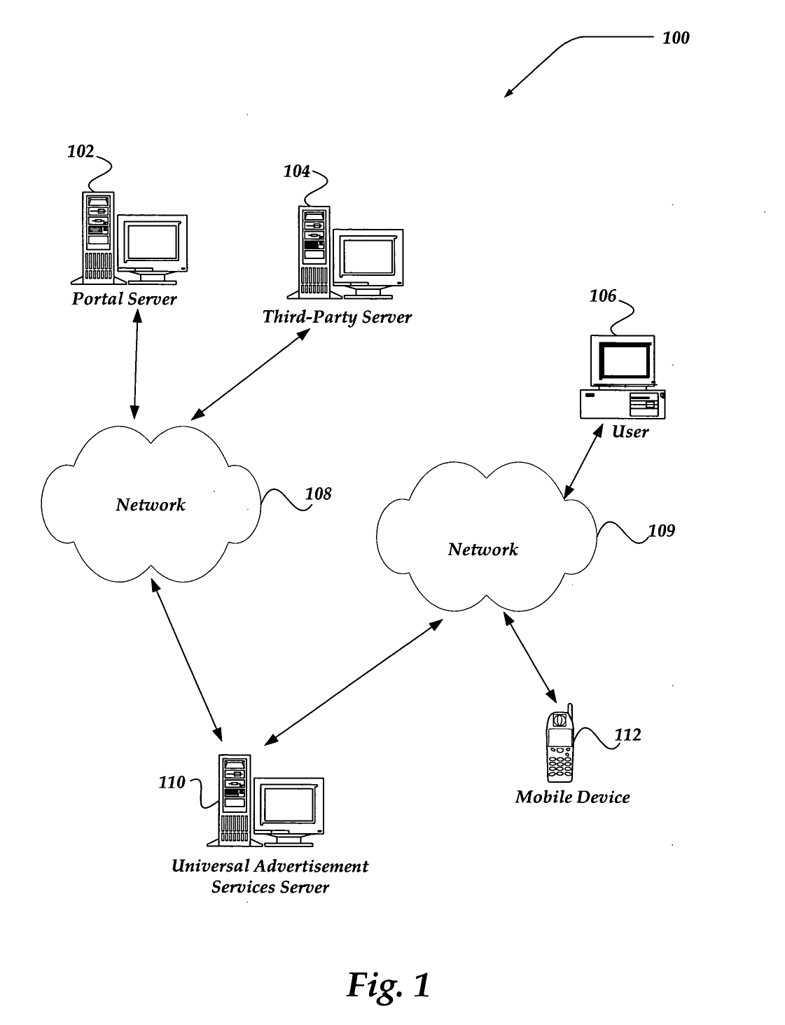

FIG. 1 illustrates one embodiment of an environment in which the present invention may operate. However, not all of these components may be required to practice the invention. Variations in the arrangement and type of the components may be made without departing from the spirit or scope of the invention.

As illustrated in FIG. 1, system 100 includes universal advertisement services server 110 which provides a unified platform for advertisement selection and distribution. System 100 further includes portal server 102 and third-party server 104 which are in communication with universal advertisement services server 110 by way of network 108. Moreover, third-party server 104 may be in communication with portal server 102 by way of network 108. It will be understood that universal advertisement services server 110 and portal server 102 may represent several computing devices, and that many third-party servers such as third-party server 104 may be included in the system. Network 108 may be regarded as a private network connection and may include, for example, a virtual private network or an encryption or other security mechanism employed over the public Internet.

System 100 also includes devices operated by end users and running browser applications or the like, including user 106 (depicted as a conventional personal computer) and web-enabled mobile device 112. Such devices are in communication with universal advertisement services server 110 by way of network 109. Network 109 may be the public Internet and may include all or part of network 108; network 108 may include all or part of network 109.

Portal server 102, third-party server 104, universal advertisement services server 110, user device 106, and mobile device 112 each represent computing devices which may generally include virtually any device that is configured to perform computation and that is capable of sending and receiving data communications by way of one or more wired and/or wireless communication interfaces. Such devices may be configured to communicate using any of a variety of network protocols. For example, user device 106 is configured to execute a browser application that employs HTTP to request information from a web server and then displays the retrieved information to a user.

Networks 108-109 are configured to couple one computing device to another computing device to enable them to communicate data. Networks 108-109 are generally enabled to employ any form of computer-readable media for communicating information from one electronic device to another. Each of networks 108-109 may include one or more of a wireless network, a wired network, a local area network (LAN), a wide area network (WAN), a direct connection such as through a Universal Serial Bus (USB) port, and the like, and may include the set of interconnected networks that make up the Internet. On an interconnected set of LANs, including those based on differing protocols, a router acts as a link between LANs, enabling messages to be sent from one to another. Communication links within LANs typically include twisted wire pair or coaxial cable. Communication links between networks may generally utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Remote computers and other electronic devices may be remotely connected to LANs or WANs by way of a modem and temporary telephone link. In essence, networks 108-109 may include any communication method by which information may travel between computing devices.

The media used to transmit information across communication links as described above illustrate one type of computer-readable media, namely communication media. Generally, computer-readable media include any media that can be accessed by a computing device. Computer-readable media may include computer storage media, network communication media, and the like. Moreover, communication media typically embody information comprising computer-readable instructions, data structures, program components, or other data in a modulated data signal such as a carrier wave, data signal, or other transport mechanism, and such media include any information delivery media. The terms “modulated data signal” and “carrier-wave signal” include a signal that has one or more of its characteristics set or changed in such a manner as to encode information, instructions, data, and the like, in the signal. By way of example, communication media include wired media such as twisted pair, coaxial cable, fiber optic cable, and other wired media, and wireless media such as acoustic, RF, infrared, and other wireless media.

Framework for Universal Advertising Services

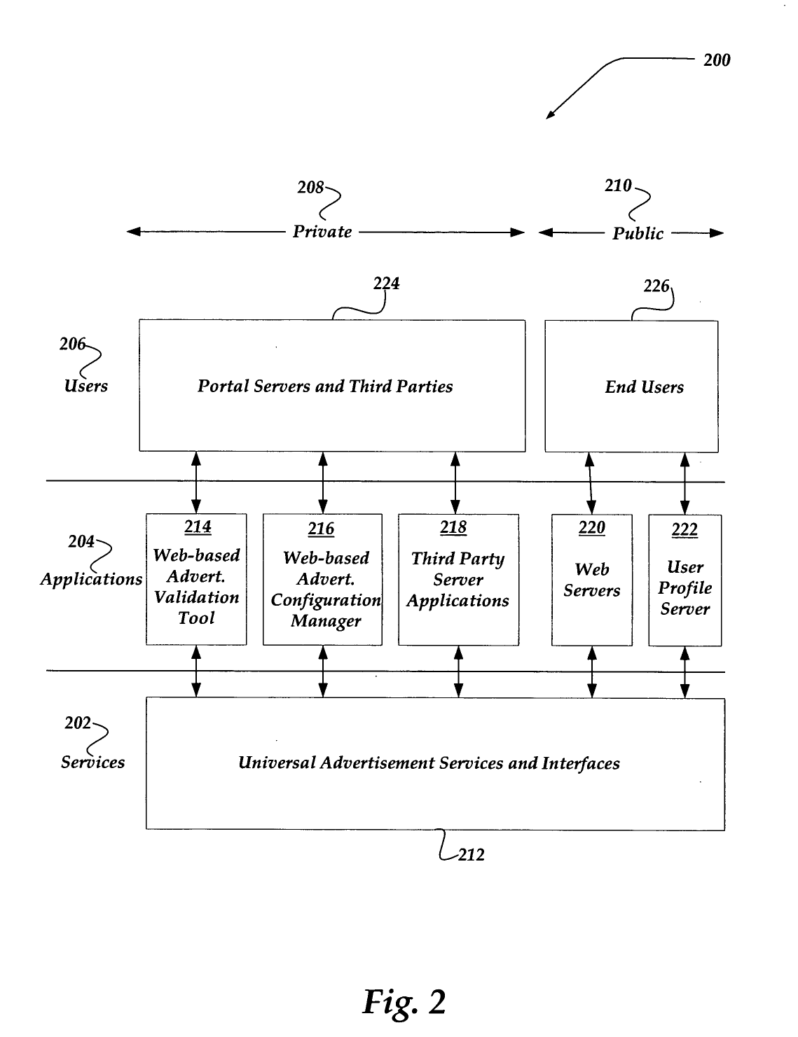

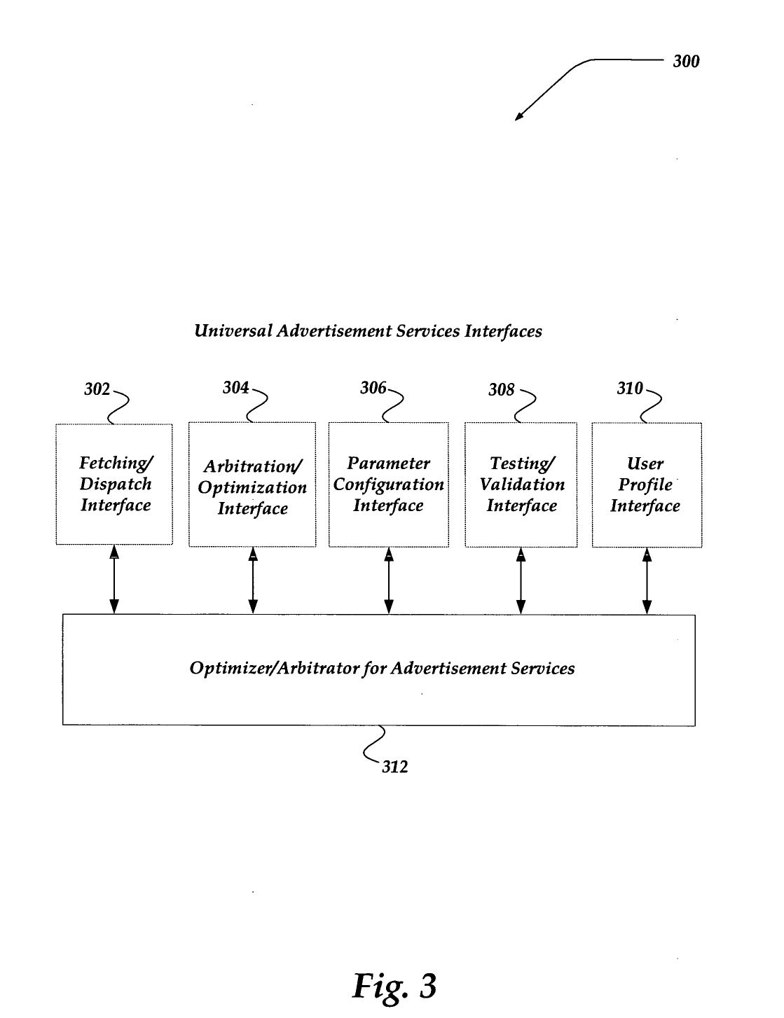

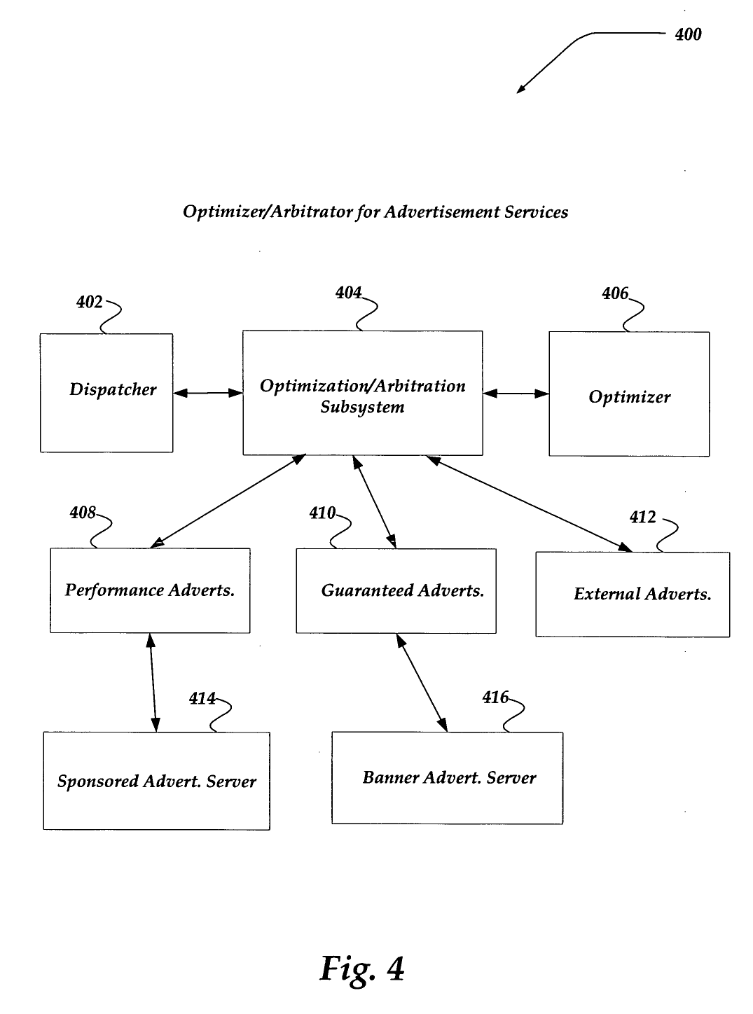

FIG. 2 illustrates elements of a multiple-tiered framework 200 for providing advertisement services that may form the basis of a system for implementing one embodiment of the invention. The advertisement services are “universal” in the sense that they unify and are applicable to advertisements of different types, such as banner advertisements and sponsored link advertisements. Framework 200 includes three layers or tiers: services 202 at the lowest tier, applications 204 in the middle, and users 206 at the highest tier. Services 202 include universal advertisement services and interfaces 212, details of which are illustrated further in FIGS. 3-4. Applications 204 interact with universal advertisement services and interfaces 212 and include, for example, web-based advertisement validation tool 214, web-based advertisement configuration manager 216, third-party server applications 218, web servers 220, and user profile server 222.

Web-based advertisement validation tool 214, web-based advertisement configuration manager 216, and third-party server applications 218 interact at the users 206 level with portal servers and third parties 224. Users belonging to portal servers and third parties 224 include, for example, portal server content managers responsible for specifying configuration parameters of web page positions and the corresponding types of advertisements, portal server managers and external portal server partners who track and validate their advertisement campaigns, and sales operators who test and validate various aspects of their advertisement campaigns. Web servers 220 and user profile server 222 interact with end users 226 who request, by standard interfaces, the most appropriate advertisements from an available inventory for specific web page positions.

At the applications 204 and users 206 tiers, framework 200 can be regarded as divided into a private 208 component and a public 210 component. Portal servers and third parties 224, interacting with web-based advertisement validation tool 214, web-based advertisement configuration manager 216, and third-party server applications 218, are private 208, while the interaction of end users 226 with web servers 220 and user profile server 222 is public 210. The private 208 and public 210 components correspond to the private and public networks 108 and 109, respectively, illustrated in FIG. 1.

FIG. 3 illustrates in further detail a set of interfaces for universal advertisement services 300 that may be provided in an embodiment of the invention. In one embodiment, the interfaces include software libraries providing access to the underlying services to higher-level applications or components, such as applications 204 and users 206 shown in FIG. 2. As shown in FIG. 3, the interfaces include fetching/dispatch interface 302, arbitration/optimization interface 304, parameter configuration interface 306, testing/validation interface 308, and user profile interface 310. These interfaces interact with and expose functionality of optimizer/arbitrator for advertisement services 312, details of which are described below in connection with FIG. 4.

Fetching/dispatch interface 302 enables fetching of appropriate advertisements, which may be based on user profile information. Arbitration/optimization interface 304 enables selection of advertisements, including selection of the best available advertisement from among a set of qualifying advertisements for a given position on a page. The selection may be based on predetermined business metrics. An example of such a metric is eCPM (effective cost per thousand, which may correspond to a click-through rate multiplied by the cost per click in performance-based pricing contexts). If a sponsored link advertisement includes a series of multiple links, the eCPM value associated with the sponsored link advertisement may be obtained by computing the average of the individual eCPM values corresponding to each link.

Parameter/configuration interface 306 is employed to control configuration of parameters needed for arbitration and delivery of advertisements, such as the type of advertisement to be served. For example, an advertiser might provide the serving rule “select a class 2 banner advertisement of size 640×80, or a set of three content-match sponsored listings based on optimal average eCPM.” Another example of a serving rule is “serve a class 1 (guaranteed impression delivery) banner advertisement, but if all class 1 banner advertisement campaigns have reached a current delivery quota, serve 50% class 2 banner advertisements and 50% user-match sponsored listings.”

Testing/validation interface 308 enables the determination whether given guidelines or criteria for a particular advertisement campaign are met, and may involve simulation. The exposure of this interface enables third-party advertisers to determine the effectiveness of an advertisement campaign before the advertising enters into production.

FIG. 4 illustrates a possible arrangement of underlying components of an optimizer/arbitrator for advertisement services 400 for retrieving qualified advertisements for a given position on a page and selecting an optimal advertisement. As shown in FIG. 4, optimizer/arbitrator 400 includes an optimization/arbitration subsystem 404 which includes or may be regarded as the arbitrator proper. Optimization/arbitration subsystem 404 interacts with or includes dispatcher 402, which communicates requests for advertisements, and optimizer 406, which enables selection of a best available advertisement based on predetermined business rules. Though not specifically shown in FIG. 4, optimization/arbitration subsystem 404 may include or be coupled to other components, including a configuration manager for enabling configuration requirements to be specified for advertisement locations in a page, and including an advertisement client server for communication between a requesting web server and dispatcher 402.

Optimization/arbitration subsystem 404 communicates with performance advertisements component 408, guaranteed impression advertisements component 410, and external advertisements component 412. Performance advertisements component 408 interacts with sponsored advertisement server 414. Similarly, guaranteed impression advertisements component 410 interacts with banner advertisement server 416. A component for serving external advertisements 412 also interacts with optimization/arbitration subsystem 404.

Generalized Operations for Providing Universal Advertisement Services

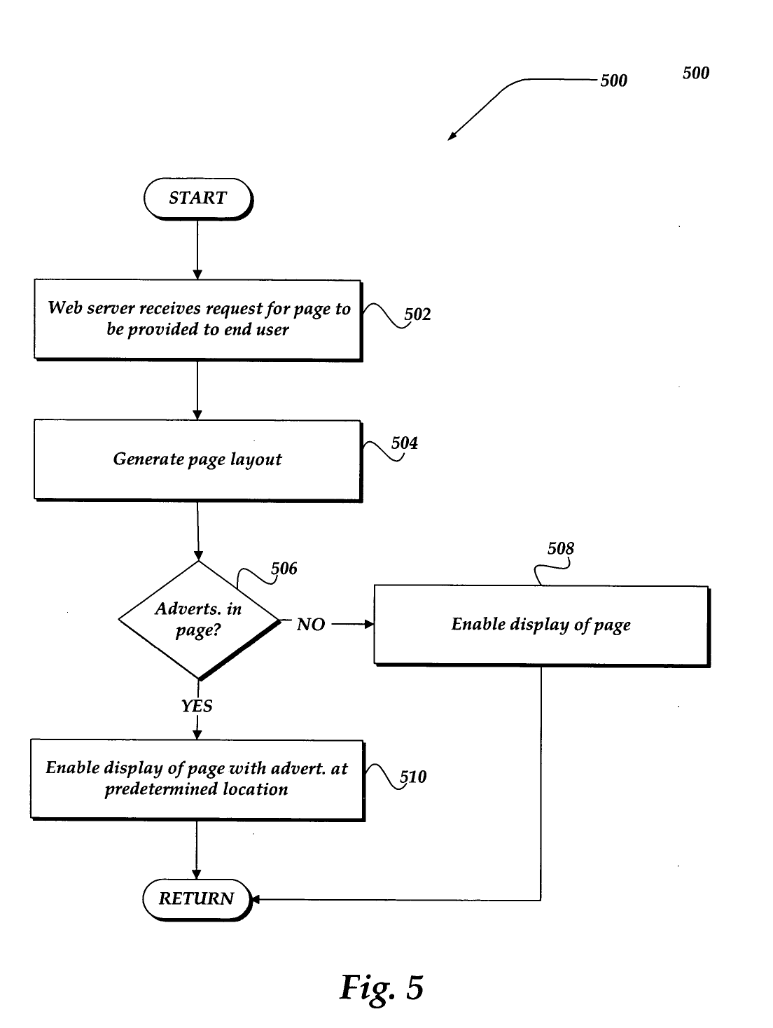

The operation of certain aspects of the invention will now be described with respect to FIGS. 5-9, which provide flow diagrams collectively illustrating a process for delivering an optimal advertisement for inclusion in a position in a page. FIG. 5 illustrates an overview process 500 for enabling the display of a page with an advertisement at a predetermined location. After a start block, process 500 flows to block 502, where a web server receives a request over a network from a browser application for a page, the page to be displayed to the end user interacting with the browser. Next, at block 504, the web server generates the page layout and content for the requested page. Process 500 then flows to decision block 506, at which it is determined whether there are any advertisements to be included in the requested page. If there is no advertisement in the requested page, process 500 branches to block 508, where the display of the page is enabled without requiring additional usage of the universal advertisement services, and processing flows to a return block and performs other actions. If, however, there is at least one advertisement in the requested page, process 500 flows to block 510, where the display of the page with the advertisement or advertisements at specified locations is enabled in a manner to be described in further detail below. Processing then flows to a return block and performs other actions.

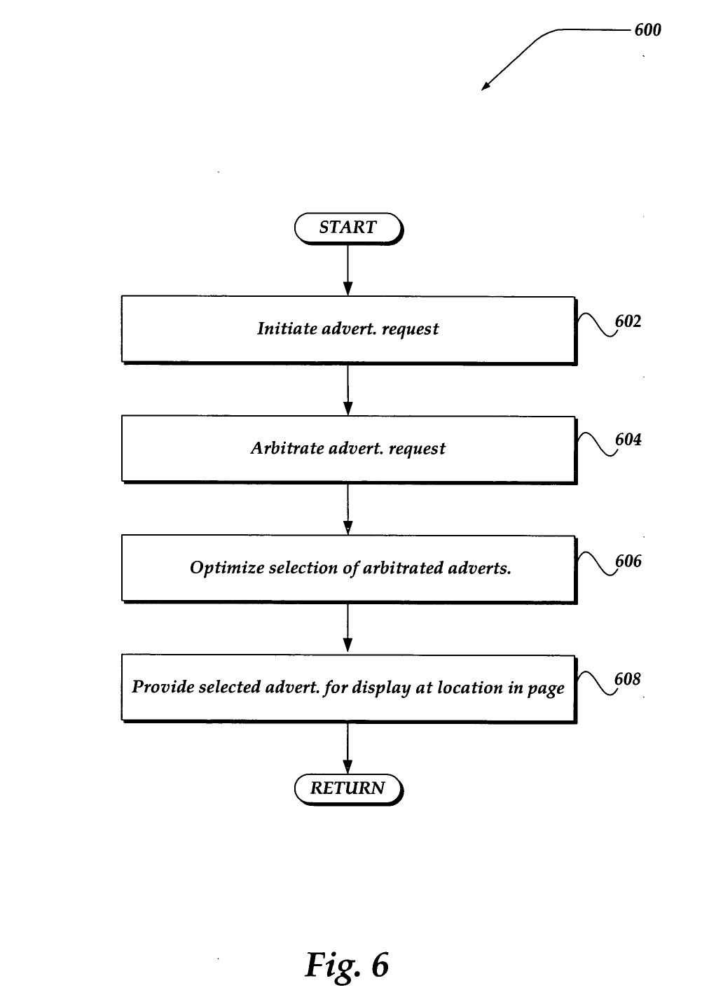

FIG. 6 is a flow diagram illustrating an overview of a process 600 for selecting an advertisement for display at a location in a page. Following a start block, process 600 flows to block 602, where a request for an advertisement for a specified page location is initiated. The process then steps to block 604, at which arbitration of the advertisement request occurs. Arbitration here includes obtaining a set of advertisements that qualify for the given page location by satisfying configuration requirements. Next, process 600 flows to block 606, where optimization of the selection of arbitrated advertisements occurs. Optimization includes selection of the best available advertisement given applicable business rules. Process 600 then steps to block 608, where the selected advertisement is provided for display at the specified location in the web page, enabling the web server to return the composed web page to the user's browser application. Process 600 then flows to a return block and performs other actions.

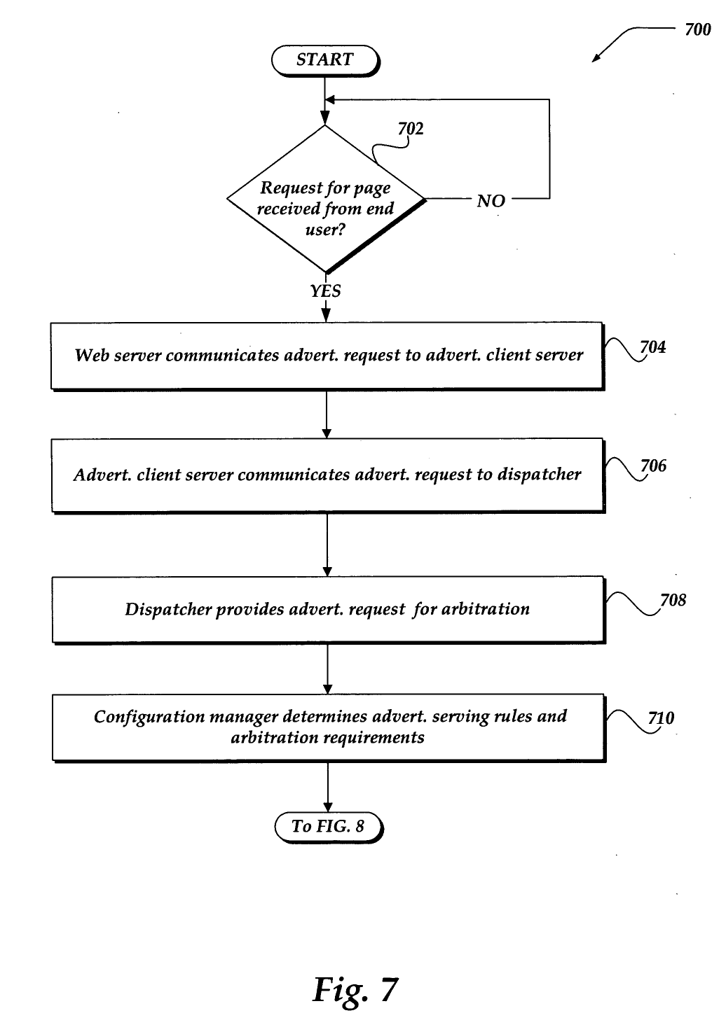

FIG. 7 is a logical flow diagram illustrating in further detail one embodiment of a process 700 for initiating arbitration of an advertisement request. As presented in the figure, the process begins, after a start block, at decision block 702, where it is determined whether a request for a page has been received by a web server from an end user by way of a browser application. The page contains at least one location for inclusion of an advertisement. If a request for a page has not been received by the web server, the process loops back to decision block 702. If a request has been received, process 700 flows to block 704, at which the web server communicates a request for the best available advertisements for the specified position or positions to an advertisement client server. The web server passes the web page and browser parameters to the advertisement client server.

Process 700 next flows to block 706, where the advertisement client server communicates the advertisement request to the dispatcher. In one embodiment, information about the user is gathered and included in the request. The advertisement client server may retrieve user cookie information based on the browser information passed by the web server. Additional user information is retrieved from the user profile server.

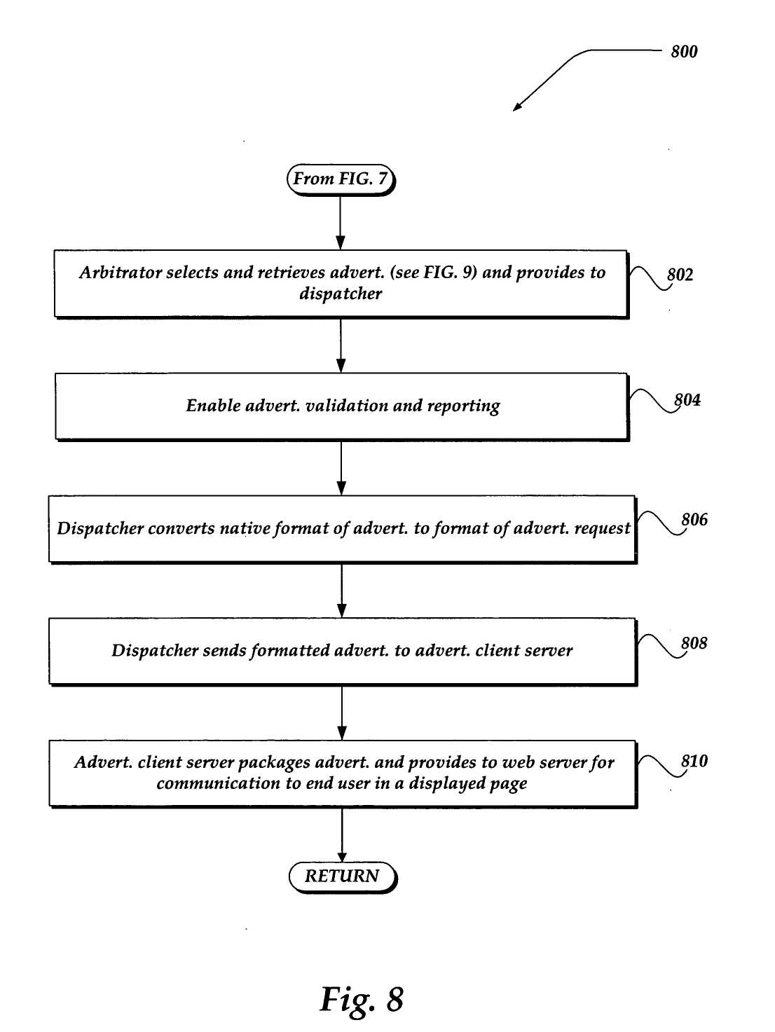

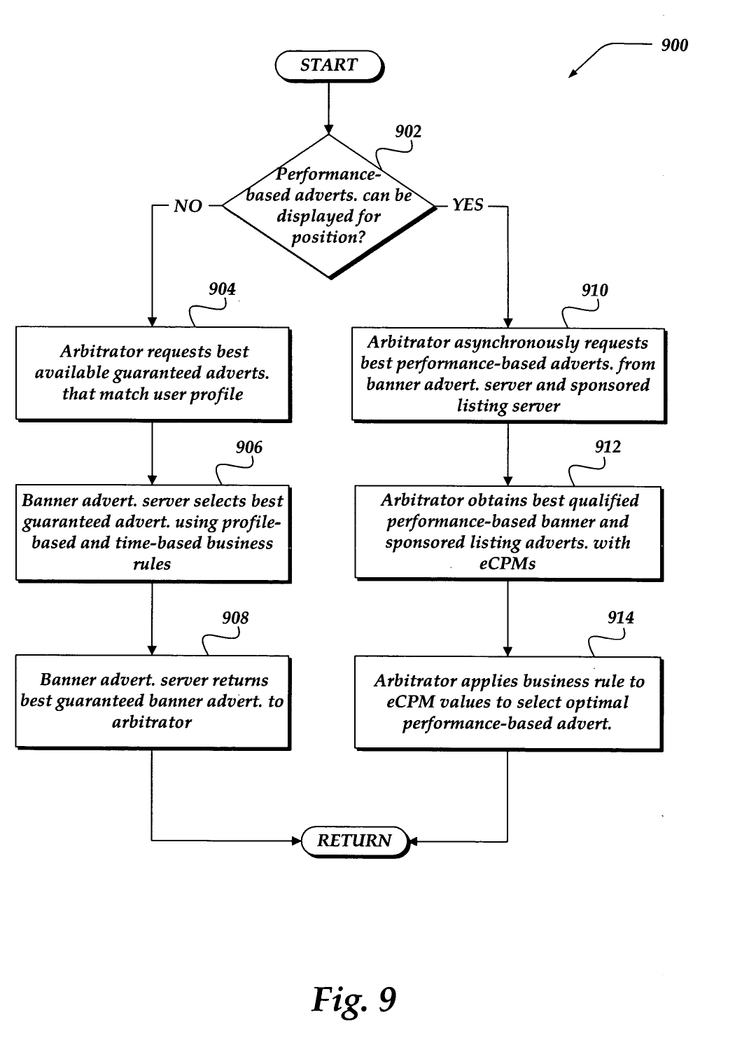

Next, at block 708, the dispatcher provides the advertisement request for arbitration of the request. In an embodiment, the dispatcher provides the request to an advertisement arbitrator. The dispatcher contacts the arbitrator once for each specific advertisement position to obtain the best advertisement for that position. Advertisement position information is passed to a configuration manager. At block 710, the configuration manager determines advertisement serving rules and arbitration requirements and provides information regarding the types of advertisements that may be displayed at the specified position on the page. Processing then continues with steps illustrated in FIGS. 8-9.

FIG. 8 continues the process illustrated in FIG. 7 and shows an overview of a process 800 for providing an arbitrated advertisement. Process 800 begins at block 802, where the arbitrator selects and retrieves the best available advertisement for a given position, in a manner illustrated in further detail in FIG. 9, and provides the advertisement to the dispatcher. At block 804, advertisement validation and reporting are enabled. As part of this step, the arbitrator may log information about advertisements that were used in the arbitration process for subsequent analysis. Process 800 then flows to block 806, where the dispatcher may convert the native format of the selected advertisement to a specified format associated with the advertisement request. Next, at block 808, the dispatcher sends the formatted advertisement to the advertisement client server. At block 810, the advertisement client server packages the selected advertisement and provides it to the web server that requested the advertisement for communication to the end user in a page displayed in a browser. Process 800 then flows to a return block and performs other actions.

The flow diagram of FIG. 9 illustrates one embodiment of a process 900 for selection of an optimized advertisement using particular rules. Following a start block, process 900 flows to decision block 902, where it is determined whether performance-based advertisements as well as guaranteed impression advertisements can be displayed for the specified page position. If not, process 900 flows to block 904, at which the arbitrator requests from a banner advertisement server the best available guaranteed impression advertisement from running advertisement campaigns that match the user profile. Next, processing steps to block 906, where the banner advertisement server obtains the best guaranteed impression advertisement using profile-based and time-based business rules. Process 900 then flows to block 908, at which the banner advertisement server passes the selected best guaranteed impression banner advertisement back to the arbitrator. Processing then flows to a return block and performs other actions.

If the decision at block 902 is affirmative, because performance-based advertisements can also be displayed in the specified page position, processing branches to block 910, where the arbitrator asynchronously requests from the banner advertisement server and a sponsored listing server the best performance-based advertisements from running campaigns. Next, at block 912, the arbitrator obtains the best qualified performance-based banner and sponsored listing advertisements along with their respective eCPM metrics. Process 900 then flows to block 914, where the arbitrator applies a business rule to the eCPM values to select the optimal performance-based advertisement. Processing then flows to a return block and performs other actions.

The above specification provides a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing advertising content for display in at least one page over a network, comprising:
obtaining a configuration for a location in a page, wherein the configuration includes a type of advertisement for display at the location;
employing the configuration to determine at least one advertisement that is qualified for display at the location in the page; and
employing at least one rule to optimize a determination of an advertisement to be displayed at the location in the page, wherein the optimized advertisement is selected from the at least one qualified advertisement.

2. The method of claim 1, wherein the type of advertisement to be displayed includes at least one of a guaranteed impression advertisement, a performance-based advertisement, a banner advertisement, or a sponsored listing advertisement.

3. The method of claim 1, wherein the type includes the size of the location in the page.

4. The method of claim 1, wherein determining the at least one qualifying advertisement further comprises determining at least one qualifying advertisement based on information regarding a user that requests the page.

5. The method of claim 1, wherein the at least one optimization rule includes at least one of a profile-based rule, a time-based rule, or a rule applied to an effective cost per impression value associated with the at least one qualifying advertisement.

6. The method of claim 1, further comprising:
recording information relating to the at least one qualifying advertisement and the optimized advertisement for validating an advertisement campaign.

7. A server for providing advertising content for display in at least one page over a network, comprising:
a network interface for communicating with a remote device that requests the advertisement;
a processor in communication with the network interface; and
a memory in communication with the processor and for use in storing data and machine instructions that enable the processor to perform a plurality of operations, including:
obtaining a configuration for a location in a page, wherein the configuration includes a type of advertisement for display at the location;
employing the configuration to determine at least one advertisement that is qualified for display at the location in the page; and
employing at least one rule to optimize a determination of an advertisement to be displayed at the location in the page, wherein the optimized advertisement is selected from the at least one qualified advertisement.

8. The server of claim 7, wherein the type of advertisement to be displayed includes at least one of a guaranteed impression advertisement, a performance-based advertisement, a banner advertisement, size, or a sponsored listing advertisement.

9. The server of claim 7, wherein determining the at least one qualifying advertisement further comprises determining at least one qualifying advertisement based on information regarding a user that requests the page.

10. The server of claim 7, wherein the at least one optimization rule includes at least one of a profile-based rule, a time-based rule, or a rule applied to an effective cost per impression value associated with the at least one qualifying advertisement.

11. The server of claim 7, further comprising:
recording information relating to the at least one qualifying advertisement and the optimized advertisement for validating an advertisement campaign

12. The server of claim 7, further comprising an interface for specifying the configuration for the location in the page.

13. The server of claim 7, further comprising an interface for validating an advertisement campaign based on the at least one qualifying advertisement and the optimized advertisement.

14. A client for displaying advertising content in at least one page over a network, comprising:
a network interface for communicating with a remote device that provides at least one advertisement;
a processor in communication with the network interface; and
a memory in communication with the processor and for use in storing data and machine instructions that enable the processor to perform a plurality of operations, including:
requesting a page to be displayed;
obtaining a configuration for a location in the requested page, wherein the configuration includes a type of advertisement for display at the location;
employing the configuration to request at least one advertisement that is qualified for display at the location in the page; and
displaying an advertisement at the location in the page based on at least one rule, wherein the at least one rule enables the optimal selection of the displayed advertisement from the at least one qualified advertisement.

15. The client of claim 14, wherein the type of advertisement to be displayed includes at least one of a guaranteed impression advertisement, a performance-based advertisement, a banner advertisement, size, or a sponsored listing advertisement.

16. The client of claim 14, wherein determining the at least one qualifying advertisement further comprises determining at least one qualifying advertisement based on information regarding a user that requests the page.

17. The client of claim 14, wherein the at least one optimization rule includes at least one of a profile-based rule, a time-based rule, or a rule applied to an effective cost per impression value associated with the at least one qualifying advertisement.

18. The client of claim 14, further comprising:
recording information relating to the at least one qualifying advertisement and the optimized advertisement for validating an advertisement campaign

19. The client of claim 14, further comprising an interface for specifying the configuration for the location in the page.

20. The client of claim 14, further comprising an interface for validating an advertisement campaign based on the at least one qualifying advertisement and the optimized advertisement.

21. A mobile device for displaying advertising content in at least one page over a network, comprising:
a network interface for communicating with a remote device that provides at least one advertisement;
a processor in communication with the network interface; and
a memory in communication with the processor and for use in storing data and machine instructions that enable the processor to perform a plurality of operations, including:
requesting a page to be displayed;
obtaining a configuration for a location in the requested page, wherein the configuration includes a type of advertisement for display at the location;
employing the configuration to request at least one advertisement that is qualified for display at the location in the requested page; and
displaying an advertisement at the location in the page based on at least one rule, wherein the at least one rule enables the optimal selection of the displayed advertisement from the at least one qualified advertisement.

22. The mobile device of claim 21, wherein the network includes at least one of a wired network and a wireless network.

23. The mobile device of claim 21, wherein the type of advertisement to be displayed includes at least one of a guaranteed impression advertisement, a performance-based advertisement, a banner advertisement, size, or a sponsored listing advertisement.

24. The mobile device of claim 21, wherein determining the at least one qualifying advertisement further comprises determining at least one qualifying advertisement based on information regarding a user that requests the page.

25. The mobile device of claim 21, wherein the at least one optimization rule includes at least one of a profile-based rule, a time-based rule, or a rule applied to an effective cost per impression value associated with the at least one qualifying advertisement.

26. The mobile device of claim 21, further comprising:
recording information relating to the at least one qualifying advertisement and the optimized advertisement for validating an advertisement campaign

27. A system for displaying advertising content in at least one page over a network, comprising:
a first device that provides an interface for communicating a requested page over the network to a second device, wherein the first device performs actions including:
specifying a configuration for a location in a page for an advertisement, and wherein the configuration requirement includes at least one type; and
employing the configuration to determine at least one advertisement that is qualified for display at the location in the requested page; and
providing an advertisement for display by the second device based on at least one rule, wherein the at least one rule enables the optimal selection of the displayable advertisement from the at least one qualified advertisement; and
the second device enables the displaying of the provided advertisement at the location in the requested page.

28. A computer-readable medium storing computer-executable instructions for providing advertising content for display in at least one page over a network, comprising:
obtaining a configuration for a location in a page, wherein the configuration includes a type of advertisement for display at the location;
employing the configuration to determine at least one advertisement that is qualified for display at the location in the page; and
employing at least one rule to optimize a determination of an advertisement to be displayed at the location in the page, wherein the optimized advertisement is selected from the at least one qualified advertisement.

29. A modulated data signal for providing advertising content for display in at least one page over a network, the modulated data signal comprising instructions that enable a computing device to perform actions, including:
obtaining a configuration for a location in a page, wherein the configuration includes a type of advertisement for display at the location;
employing the configuration to determine at least one advertisement that is qualified for display at the location in the page; and
employing at least one rule to optimize a determination of an advertisement to be displayed at the location in the page, wherein the optimized advertisement is selected from the at least one qualified advertisement.
